(19) United States
(12) Patent Application Publication
(10) Pub. No.: US 2006/0105742 A1
(43) Pub. Date: May 18, 2006

(54) Method for issuing instant mobile card using wireless network and accounting it using short distance communication

(76) Inventors: Yun Kyung Kim, Seoul (KR); Young Ye Heo, Seoul (KR)

Correspondence Address: SCHMEISER OLSEN & WATTS, 18 E UNIVERSITY DRIVE, SUITE # 101, MESA, AZ, 85201, US

(21) Appl. No.: 10/533,466

(22) PCT Filed: May 23, 2003
(86) PCT No.: PCT/KR03/01013

§ 371 Date: Apr. 29, 2005

(30) Foreign Application Priority Data
Oct. 31, 2002 (KR) 10-2002-0066979

(51) Int. Cl. H04M 1/66

(52) U.S. Cl. 455/411

(57) ABSTRACT

The invention relates to a method of issuing an instant mobile card using a wireless network and processing a payment using short-range communication and a computer-readable recording medium for storing a program for executing the method. In the instant mobile car issuing method, an instant mobile card issuing request is received from the mobile terminal, the user is authenticated by using a secret number and a phone number o the mobile terminal as an authentication key value, and an instant mobile card number is transmitted to the mobile terminal. Further, in the instant mobile card payment processing method using short-range communication, the instant mobile card number and payment information are received from a card reader terminal, a payment is processed with a physical card number mapped to the instant mobile card number, and approval is transmitted to the card reader terminal.

### TECHNICAL FIELD

The present invention relates, in general, to a method of issuing an instant mobile card using a wireless network and processing a payment using short-range communication and a computer-readable recording medium for storing a program for executing the method and, more particularly, to a method of issuing an instant mobile card using a wireless network and processing a payment using short-range communication and a computer-readable recording medium for storing a program for executing the method, which are applied to the wireless network and personal mobile terminals.

### BACKGROUND ART

Generally, electronic commerce (e-commerce) represents transactions of allowing consumers to be provided with commodities or services through networks, of which the Internet is representative, and to pay fees for the commodities or the services.

Such e-commerce has been recently spotlighted because of advantages in which it enables a consumer to obtain various pieces of information without physically visiting an establishment and to conveniently perform a transaction, with the rapid development of the Internet.

When a fee for such e-commerce is paid, a variety of cards (including advance payment cards, deferred payment cards, credit cards and department store cards) are generally used. However, this payment method is problematic in that risk factors, such as the illegal or unauthorized use of cards caused by the leakage and hacking of personal information due to the external disclosure thereof occurring while transmitting the information of various cards through a network, hinder the activation of the e-commerce.

In the meantime, even in a case where credit cards are used off-line, there is a problem in that the illegal use of credit cards due to the loss and theft of the credit cards and the leakage of credit card information including credit card numbers cannot be efficiently prevented.

In order to solve the above problems, a method of mounting an Integrated Circuit (IC) chip including credit card information on a mobile terminal, or storing credit card information in a memory of the mobile terminal and capable of utilizing the mobile terminal in substitution for a credit card has been proposed.

However, such a conventional method is problematic in that the illegal use of a mobile terminal cannot be prevented until a user reports a theft or loss of the mobile terminal when the user loses the mobile terminal.

In the meantime, since about 30 three-digit or four-digit numbers are printed on a card-shaped random number table issued from a bank when a user applies to the bank for Internet banking or telebanking services, that is, a security card, the user must personally search the table for a numeral corresponding to a designated number and enter the numeral whenever performing an account transfer or another account transaction.

However, there is a problem in that a user must carry a security card whenever performing a transaction, and cannot use the security card until the security card is issued again when losing the security card.

Further, when desiring to open a new account at the time of typical bank transaction, the user should open an account with a bank and be issued with a passbook.

However, in this case, the user should consistently and physically visit the bank to be issued with the passbook, arrange the passbook whenever performing a later transaction, and update the passbook to another one by paying a fee when losing the passbook.

### DISCLOSURE OF THE INVENTION

Accordingly, the present invention has been made keeping in mind the above problems occurring in the prior art, and an object of the present invention is to provide a method of issuing an instant mobile card using a wireless network and processing a payment using short-range communication, which issues an instant mobile card number to a user through a mobile communication terminal thereof, and processes a payment with the mobile card number using short-range communication, thus guaranteeing the security of card payment.

Another object of the present invention is to provide a computer-readable recording medium for storing a program to execute a function of guaranteeing the security of card payment by issuing an instant mobile card number to a user through a mobile communication terminal thereof and by processing a payment with the mobile card number using short-range communication.

In order to accomplish the above objects, the present invention provides an instant mobile card issuing method using a wireless network, which provides an instant mobile card number to a mobile terminal of a user to guarantee security when using cards, the method comprising the 1st step of receiving a request for issue of an instant mobile card from the mobile terminal; the 2nd step of authenticating the user by using a secret number and a phone number of the mobile terminal as an authentication key value; and the 3rd step of transmitting an instant mobile card number to the mobile terminal.

Further, the present invention provides an instant mobile card payment processing method using short-range communication, which processes a payment with the instant mobile card issued by the instant mobile card issuing method, the payment processing method comprising the 1st step of receiving the instant mobile card number and payment information from a card reader terminal; the 2nd step of processing a payment with a physical card number mapped to the instant mobile card number; and the 3rd step of transmitting approval to the card reader terminal.

Further, the present invention provides a computer-readable recording medium storing a program for executing functions in an instant mobile card issuing apparatus provided with a microprocessor so as to provide an instant mobile card issuing method of providing an instant mobile card number to a mobile terminal of a user to guarantee security when using cards, the functions comprising the 1st function of receiving a request for issue of an instant mobile card from the mobile terminal; the 2nd function of authenticating the user by using a secret number and a phone number of the mobile terminal as an authentication key value; and the 3rd function of transmitting an instant mobile card number to the mobile terminal.

Further, the present invention provides a computer-readable recording medium storing a program for executing functions in an instant mobile card payment processing apparatus provided with a microprocessor so as to provide an instant mobile card payment processing method of processing a payment with the instant mobile card issued by the instant mobile card issuing method, the functions comprising the 1st function of receiving the instant mobile card number and payment information from a card reader terminal; the 2nd function of processing a payment with a physical card number mapped to the instant mobile card number; and the 3rd function of transmitting approval to the card reader terminal.

### BRIEF DESCRIPTION OF THE DRAWINGS

FIG. 1 is a view showing the construction of a system for issuing an instant mobile card using a wireless network and processing a payment with the mobile card using short-range communication according to the present invention;

FIG. 2 is a flowchart of a method of issuing an instant mobile card using a wireless network according to an embodiment of the present invention; and

FIG. 3 is a flowchart of a method of processing a payment with the instant mobile card using short-range communication according to an embodiment of the present invention.

### DESCRIPTION OF REFERENCE CHARACTERS OF IMPORTANT PARTS

110: instant mobile card issuing server 120: card issuing company main server

130: card issuing company payment processing server 140: base station

150: card reader terminal 160: short-range communication receiver

170: mobile terminal

### BEST MODE FOR CARRYING OUT THE INVENTION

Hereinafter, embodiments of the present invention will be described in detail with reference to the attached drawings.

First, when a detailed description of embodiments of the present invention is performed, a method of issuing an instant credit card is described. In this case, it is apparent to those skilled in the art that the present invention can also be applied to the issue of security cards and account numbers performed in a bank.

In conventional on-line e-commerce, there is a limitation in that clients requested to enter various card numbers are stressed from the leakage of their card numbers at the time of purchasing a commodity, thus hesitating in purchasing a commodity.

In this case, the present invention provides an instant mobile card number, in which a phone number of a mobile terminal is used as a main authentication key value, and allows a user to use the instant mobile card number, thus preventing the leakage of personal information and providing the security of card payment.

Further, the present invention allows a user to use the instant mobile card number issued through a wireless network even when the user does not carry his or her card in on/off-line commerce, thus enabling the user to pay in the same manner as that of a case where the user carries a physical card.

The instant mobile card number of the present invention can minimize the risk of losing a physical card and the leakage of various pieces of card information, which may occur when a user carries the physical card, and can be used in on/off-line affiliation stores.

Further, an instant mobile card number service of the present invention can be used in association with credit cards, department store cards, advance/deferred payment cards and other cards. Further, if the approval of a user is obtained, the instant mobile card number can be used even in the case where the user has not yet received a physical card or does not desire to be issued with a physical card, thus enabling the mobile card to be used as a card having the same validity as that of an existing card until the physical card is received.

That is, the issued instant mobile card can be regarded as having the same functions and provisions as other physical cards.

Further, the instant mobile card issued according to the present invention has volatility regardless of whether or not a user uses the instant mobile card.

That is, if the user does not use the instant mobile card, the authority to use the issued instant mobile card number can be limited after a certain period has elapsed.

Further, the present invention enables a user to select a desired payment card through a wired/wireless network before payment, so that the user can use various cards using a single mobile terminal.

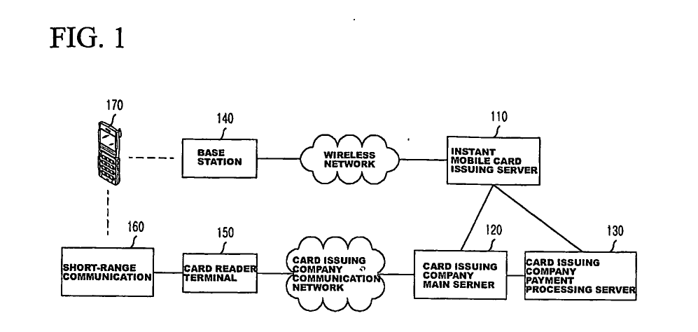

FIG. 1 is a view showing the construction of a system for issuing an instant mobile card using a wireless network and processing a payment using short-range communication according to the present invention.

As shown in FIG. 1, the system for issuing an instant mobile card and processing a payment according to the present invention includes an instant mobile card issuing server 110, a card issuing company main server 120 and a card issuing company payment processing server 130.

The instant mobile card issuing server 110 can transmit an instant mobile card to a mobile terminal 170 while communicating with a base station 140 through a wireless network, and the card issuing company main server 120 can communicate with a card reader terminal 150 of each store through a card issuing company communication network.

The card issuing company may include banks, credit card companies, card sales departments of department stores and discount markets, etc.

The instant mobile card issuing server 110 functions to issue and transmit an instant mobile card to the mobile terminal 170 of a user through the wireless network.

“The issue of the instant mobile card” used in the present invention represents a procedure of actually generating and transmitting an instant mobile card number.

All instant mobile cards issued according to the present invention are recorded and managed by the instant mobile card issuing server 110, and the recorded information can be permanently or temporarily preserved depending on the selection of an operator.

Further, the instant mobile card issuing server 110 uses a phone number of the mobile terminal 170 as a main authentication key value, and functions to perform various authenticating operations required for wireless services.

When receiving an instant mobile card from the mobile terminal 170 through the card reader terminal 150 in short-range communication manner, or when receiving payment information corresponding to the instant mobile card issued to the mobile terminal 170 from a payment system (not shown), the card issuing company main server 120 functions to transmit a corresponding instant mobile card number to the instant mobile card issuing server 110.

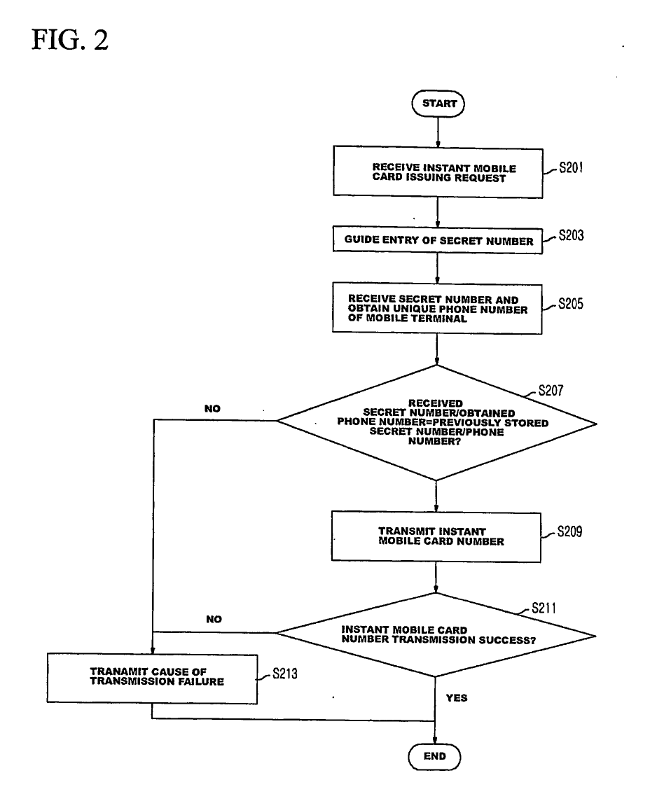

Further, the card issuing company main server 120 functions to receive approval from the card issuing company payment processing server 130 and transmit the approval to the card reader terminal 150 or the payment system. FIG. 2 is a flowchart of an instant mobile card issuing method using a wireless network according to an embodiment of the present invention.

For the utilization of the present invention, a user must apply to a card issuing company for the use of an instant mobile card in advance in a wired or wireless manner.

As shown in FIG. 2, in the instant mobile card issuing method of the present invention, a request for the issue of an instant mobile card is received from the mobile terminal 170 of the user through the wireless network at step S201.

Thereafter, the entry of a secret number is guided at step S203, and a unique phone number of the mobile terminal 170 is obtained at the same time that a response to the guidance is received at step S205. It is determined whether both the entered secret number and the obtained phone number of the mobile terminal 170 are identical with a secret number and a phone number of the mobile terminal, respectively, which have been previously stored at step S207.

If it is determined that the entered secret number and the obtained phone number are identical with the previously stored secret number and phone number, respectively, an instant mobile card number is transmitted to the mobile terminal 170 at step S209. At this time, a validity period of the instant mobile card number may be transmitted together with the instant mobile card number.

Thereafter, it is determined whether the transmission of the instant mobile card number results in success at step S211. If the transmission fails, a cause of the transmission failure is transmitted to the mobile terminal 170 at step S213.

The instant mobile card issuing method of the present invention may provide a function of allowing the user to confirm the use of the instant mobile card number by transmitting a short message to the user mobile terminal 170 in the case where a payment is processed using the instant mobile card number.

Information transmitted/received between the instant mobile card issuing server 110 and the mobile terminal 170 is encrypted in an End-to-End (E2E) manner. That is, the present invention further provides encryption performed between the user mobile terminal 170 and the instant mobile card issuing server 110 besides encryption basically provided from the wireless network, thus securely protecting user information.

However, the instant mobile card issuing method of the present invention does not require the installation of an additional program by the user so as to realize the protection and encryption of the user information.

Further, the instant mobile card issuing method of the present invention enables the user to easily change a desired card to be used through the wired/wireless network.

The instant mobile card issued according to the present invention can be used in on/off-line affiliated stores in the same manner as that of an existing card, and the instant mobile card number is mapped to the existing card number, so that approval/payment procedures are executed with respect to the existing card.

Hereinafter, a method of processing a payment with a previously issued instant mobile card using short-range communication in an affiliated store is described.

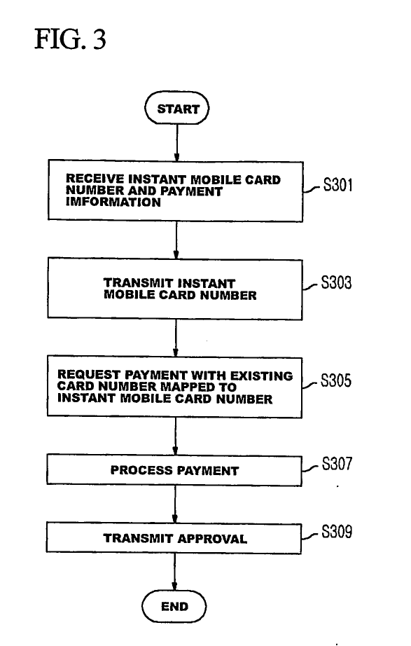

FIG. 3 is a flowchart of the instant mobile card payment processing method using short-range communication according to an embodiment of the present invention.

The user may receive the instant mobile card number and transmit the information of the corresponding instant mobile card to the card reader terminal 150 using the short-range communication between the mobile terminal 170 and the short-range communication receiver 160.

The short-range communication may be infrared communication or Bluetooth communication.

As shown in FIG. 3, in the instant mobile card payment processing method of the present invention, when receiving an instant mobile card number and payment information from the card reader terminal 150 at step S301, the card issuing company main server 120 transmits the instant mobile card number to the instant mobile card issuing server 110 at step S303.

The instant mobile card issuing server 110 requests the card issuing company payment processing server 130 to process a payment using an existing card number mapped to the instant mobile card number at step S305.

The card issuing company payment processing server 130 processes the payment at step S307, and transmits approval to the card reader terminal 150 at step S309.

The instant mobile card payment processing method of the present invention may provide a function of allowing the user to confirm the use of the instant mobile card by transmitting a short message to the user mobile terminal 170 in the case where a payment is processed using the instant mobile card number.

The above-described method of the present invention can be implemented by a program and stored in a computer-readable recording medium (a Compact Disc-Read Only Memory: CD-ROM, a Random Access Memory (RAM), a ROM, a floppy disc, a hard disc, a magneto-optical disc, etc.).

### INDUSTRIAL APPLICABILITY

As described above, the present invention provides a method of issuing an instant mobile card using a wireless network and processing a payment using short-range communication and a computer-readable recording medium for storing a program for executing the method, which provide the instant mobile card through the wireless network, thus guaranteeing the security of the use of cards and preventing the leakage of personal information.

Further, the present invention is advantageous in that it provides the instant mobile card through the wireless network, thus providing a convenience in that there is no need to carry a physical credit card to carry out a payment.

Further, the present invention is advantageous in that it issues an instant mobile card number to a user, thus preventing the risk of illegal use of credit cards due to the loss or the appropriation thereof, which may occur when credit card information is stored in a memory or an IC chip of a mobile terminal in the prior art or when the user carries physical credit cards.

Moreover, the present invention is advantageous in that it allows the user to freely change the type of card within a preset range of the types of cards whenever the user carries out a payment.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An instant mobile card issuing method using a wireless network, which provides an instant mobile card number to a mobile terminal of a user to guarantee security when using cards, the method comprising:
the 1st step of receiving a request for issue of an instant mobile card from the mobile terminal;
the 2nd step of authenticating the user by using a secret number and a phone number of the mobile terminal as an authentication key value; and
the 3rd step of transmitting an instant mobile card number to the mobile terminal.

2. The instant mobile card issuing method according to claim 1, wherein the instant mobile card number is a credit card number.

3. The instant mobile card issuing method according to claim 1, wherein the instant mobile card number is a security card number.

4. The instant mobile card issuing method according to claim 1, wherein the instant mobile card number is a bank account number.

5. The instant mobile card issuing method according to any of claims 1 to 4, further comprising the 4th step of transmitting a validity period of the instant mobile card number together with the instant mobile card number.

6. The instant mobile card issuing method according to claim 1, wherein the 2nd step comprises:
the 5th step of guiding an entry of the secret number;
the 6th step of receiving the secret number from the mobile terminal and obtaining the phone number of the mobile terminal simultaneously with the reception of the secret number; and
the 7th step of determining whether the received secret number and the obtained phone number of the mobile terminal are identical with a secret number and a phone number of the mobile terminal, respectively, which have been previously stored.

7. The instant mobile card issuing method according to claim 6, wherein the 2nd step further comprises the 8th step of transmitting a cause of a failure to the mobile terminal when the received secret number and the obtained phone number are not identical with the previously stored secret number and phone number, respectively, at the 7th step.

8. The instant mobile card issuing method according to claim 1, wherein the 3rd step comprises:
the 5th step of determining whether the mobile terminal receives the instant mobile card number; and
the 6th step of transmitting a cause of a reception failure to the mobile terminal when the reception of the instant mobile card number fails at the 5th step.

9. An instant mobile card payment processing method using short-range communication, which processes a payment with the instant mobile card issued by the instant mobile card issuing method of claims 1 to 8, the payment processing method comprising:
the 1st step of receiving the instant mobile card number and payment information from a card reader terminal;
the 2nd step of processing a payment with a physical card number mapped to the instant mobile card number; and
the 3rd step of transmitting approval to the card reader terminal.

10. The instant mobile card payment processing method according to claim 9, wherein the card reader terminal receives the instant mobile card number from the mobile terminal using the short-range communication.

11. The instant mobile card payment processing method according to claim 10, wherein the short-range communication is infrared communication.

12. The instant mobile card payment processing method according to claim 10, wherein the short-range communication is Bluetooth communication.

13. The instant mobile card payment processing method according to claim 9, further comprising the 4th step of transmitting a short message related to completion of the payment to the mobile terminal when the processing of payment with the instant mobile card has been completed.

14. A computer-readable recording medium storing a program for executing functions in an instant mobile card issuing apparatus provided with a microprocessor so as to provide an instant mobile card issuing method of providing an instant mobile card number to a mobile terminal of a user to guarantee security when using cards, the functions comprising:
the 1st function of receiving a request for issue of an instant mobile card from the mobile terminal;
the 2nd function of authenticating the user by using a secret number and a phone number of the mobile terminal as an authentication key value; and
the 3rd function of transmitting an instant mobile card number to the mobile terminal.

15. A computer-readable recording medium storing a program for executing functions in an instant mobile card payment processing apparatus provided with a microprocessor so as to provide an instant mobile card payment processing method of processing a payment with the instant mobile card issued by the instant mobile card issuing method of claims 1 to 8, the functions comprising:
the 1st function of receiving the instant mobile card number and payment information from a card reader terminal;
the 2nd function of processing a payment with a physical card number mapped to the instant mobile card number; and
the 3rd function of transmitting approval to the card reader terminal.
